(19) United States
(12) Patent Application Publication
(10) Pub. No.: US 2018/0367935 A1
(43) Pub. Date: Dec. 20, 2018

(54) AUDIO SIGNAL PROCESSING METHOD, AUDIO POSITIONAL SYSTEM AND NON-TRANSITORY COMPUTER-READABLE MEDIUM

(71) Applicant: HTC Corporation, Taoyuan City (TW)

(72) Inventor: Chun-Min LIAO, Taoyuan City (TW)

(21) Appl. No.: 16/009,212

(22) Filed: Jun. 15, 2018

Related U.S. Application Data
(60) Provisional application No. 62/519,874, filed on Jun. 15, 2017.

(51) Int. Cl. H04S 7/00; H04S 1/00; H04R 5/04

(52) U.S. Cl. CPC H04S 7/302; H04S 2420/01; H04R 5/04; H04S 1/002

(57) ABSTRACT

An audio signal processing method, audio positional system and non-transitory computer-readable medium are provided in this disclosure. The audio signal processing method includes steps of: determining, by a processor, whether a first head related transfer function (HRTF) is selected to be applied onto an audio positional model corresponding to a first target or not; loading, by the processor, a plurality of parameters of a second target if the first HRTF is not selected; modifying, by the processor, a second HRTF according to the parameters of the second target; and applying, by the processor, the second HRTF onto the audio positional model corresponding to the first target to generate an audio signal.

### CROSS-REFERENCE TO RELATED APPLICATION

This application claims priority to U.S. Provisional Application Ser. No. 62/519,874, filed on Jun. 15, 2017, which is herein incorporated by reference.

BACKGROUND

Field of Invention

The present application relates to a processing method. More particularly, the present application relates to an audio signal processing method for simulating the hearing of different characters.

Description of Related Art

In the current virtual reality (VR) environment, the avatar may be non-human species, e.g. elf, giant, animals and so on. Usually, the three dimensions audio position technique is utilized a head-related transfer function (HRTF) to simulate the hearing of the avatar. HRTF is utilized to simulate how an ear receives a sound from a point in three dimensions space. However, HRTF is usually used to simulate the human hearing, if the avatar is non-human species, HRTF will not be able to simulate real hearing of the avatar, and therefore the player will not have the best experience in the virtual reality environment.

### SUMMARY

An aspect of the disclosure is to provide an audio signal processing method. The audio signal processing method includes operations of: determining whether a first head related transfer function (HRTF) is selected to be applied on an audio positional model corresponding to a first target or not; loading a plurality of parameters of a second target if the first HRTF is not selected; modifying a second HRTF according to the parameters of the second target; and applying the second HRTF onto the audio positional model corresponding to the first target to generate an audio signal.

Another aspect of the disclosure is to provide an audio positional system. The audio positional system includes an audio outputting module, a processor and a non-transitory computer-readable medium. The non-transitory computer-readable medium comprising one or more sequences of instructions to be executed by the processor for performing an audio signal processing method, includes operations of: determining whether a first head related transfer function (HRTF) is selected to be applied on an audio positional model corresponding to a first target or not; loading a plurality of parameters of a second target if the first HRTF is not selected; modifying a second HRTF according to the parameters of the second target; and applying the second HRTF onto an audio positional model corresponding to the first target to generate an audio signal.

Another aspect of the disclosure is to provide a non-transitory computer-readable medium including one or more sequences of instructions to be executed by a processor of an electronic device for performing an audio signal processing method, wherein the audio signal processing method includes operations of: determining whether a first head related transfer function (HRTF) is selected to be applied on an audio positional model corresponding to a first target or not; loading a plurality of parameters of a second target if the first HRTF is not selected; modifying a second HRTF according to the parameters of the second target; and applying the second HRTF onto the audio positional model corresponding to the first target to generate an audio signal.

Based on aforesaid embodiments, the audio signal processing method is capable of modifying the parameters of the HRTF according to the parameters of character, modifying the audio signal according to the modified HRTF and outputting the audio signal. The audio signal is able to be modified according to different parameters of avatar.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a functional block diagram illustrating an audio positional system according to an embodiment of the disclosure.

FIG. 2 is a flow diagram illustrating an audio signal processing method according to an embodiment of this disclosure.

FIG. 3 is a flow diagram illustrating step S240 according to an embodiment of this disclosure.

FIG. 4A and FIG. 4B are schematic diagram illustrating the head shape of avatar.

FIG. 5A and FIG. 5B are schematic diagram illustrating the head shape of avatar.

FIG. 6A and FIG. 6B are schematic diagram illustrating relation between the target and the audio source.

### DETAILED DESCRIPTION

It will be understood that, in the description herein and throughout the claims that follow, when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Moreover, “electrically connect” or “connect” can further refer to the interoperation or interaction between two or more elements.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, words indicating direction used in the description of the following embodiments, such as “above,” “below,” “left,” “right,” “front” and “back,” are directions as they relate to the accompanying drawings. Therefore, such words indicating direction are used for illustration and do not limit the present disclosure.

It will be understood that, in the description herein and throughout the claims that follow, unless otherwise defined, all terms (including technical and scientific terms) have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. § 112(f). In particular, the use of “step of” in the claims herein is not intended to invoke the provisions of 35 U.S.C. § 112(f).

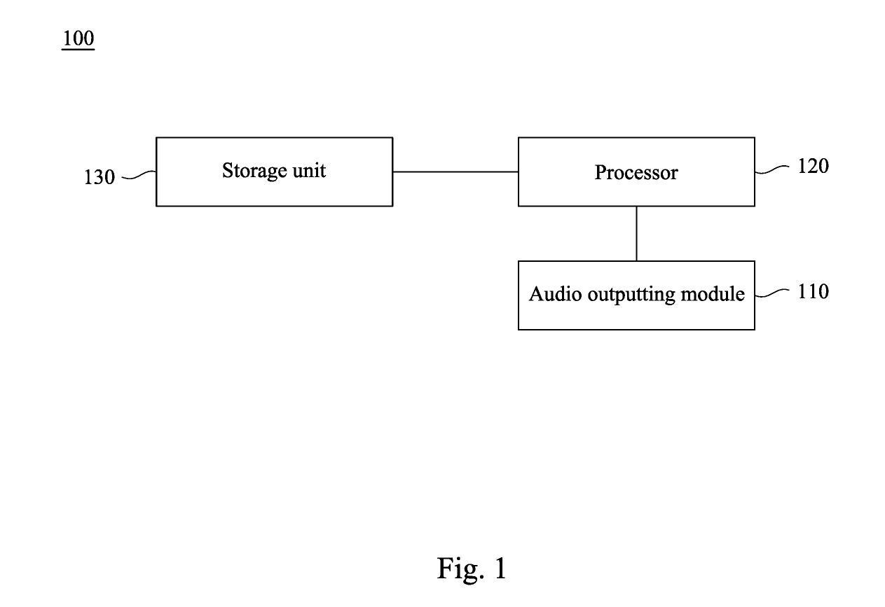

Reference is made to FIG. 1, which is a functional block diagram illustrating an audio positional system 100 according to an embodiment of the disclosure. As shown in FIG. 1, the audio positional system 100 includes an audio outputting module 110, a processor 120 and a storage unit 130. The audio outputting module 110 can be implemented by an earpiece or a sound. The processor 120 can be implemented by a central processing unit, a control circuit and/or a graphics processing unit. The storage unit 130 can be implemented by a memory, a hard disk, a flash drive, a memory card, etc. The audio positional system 100 can be implemented by a head-mounted device (HMD).

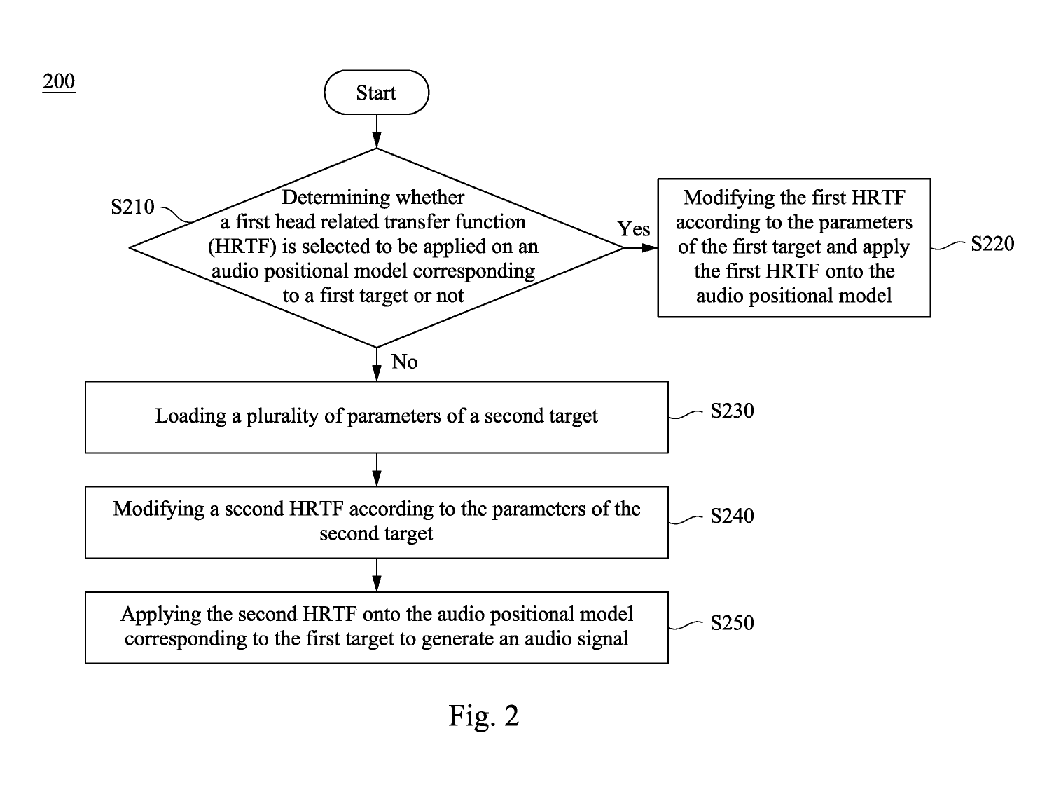

The processor 120 is electrically connected to the audio outputting module 110 and the storage unit 130. The audio outputting module 110 is configured to output an audio signal, and the storage unit 130 is configured to store the non-transitory computer-readable medium. The head-mounted device is configured to execute the audio positional model and display a virtual reality environment. Reference is made to FIG. 2, which is a flow diagram illustrating an audio signal processing method 200 according to an embodiment of this disclosure. In the embodiment, the audio signal processing method 200 is executed by the processor 120 and it can be utilized to modify the parameters of the HRTF according to the target parameters of avatar and output modified audio signal by the audio outputting module 110.

Reference is made to FIG. 1 and FIG. 2. As the embodiment shown in FIG. 2, the audio signal processing method 200 firstly executes step S210 to determine whether a first head related transfer function (HRTF) is selected to be applied on an audio positional model corresponding to a first target or not; if the first HRTF is selected, the audio signal processing method 200 further executes step S220 to modify the first HRTF according to the parameters of the first target and apply the first HRTF onto the audio positional model. In the embodiment, the parameters of the first target are detected by the sensors of the head-mounted device, and the parameters of the first target are capable of applying in the first HRTF. For example, the parameters of the first target can realize with the head size of user.

Afterward, the audio signal processing method 200 further executes step S230 to load a plurality of parameters of a second target when the first HRTF is not selected. In the embodiment, the parameters of the second target include a sound loudness, a timbre, an energy difference of audio source, and/or a time difference of the audio source. The energy difference of and/or the time difference of audio source respectively emitted toward a right-side and a left-side of the second target. The character simulating parameter set can include a material of the second target and an appearance of the second target. For example, different species have different ears shape and the location of ears, such as cat's ears and human ears. Human ears are located on the two sides of the head, and cat's ears are located on the top side of the head. Moreover, different targets have different material, such as robot and human.

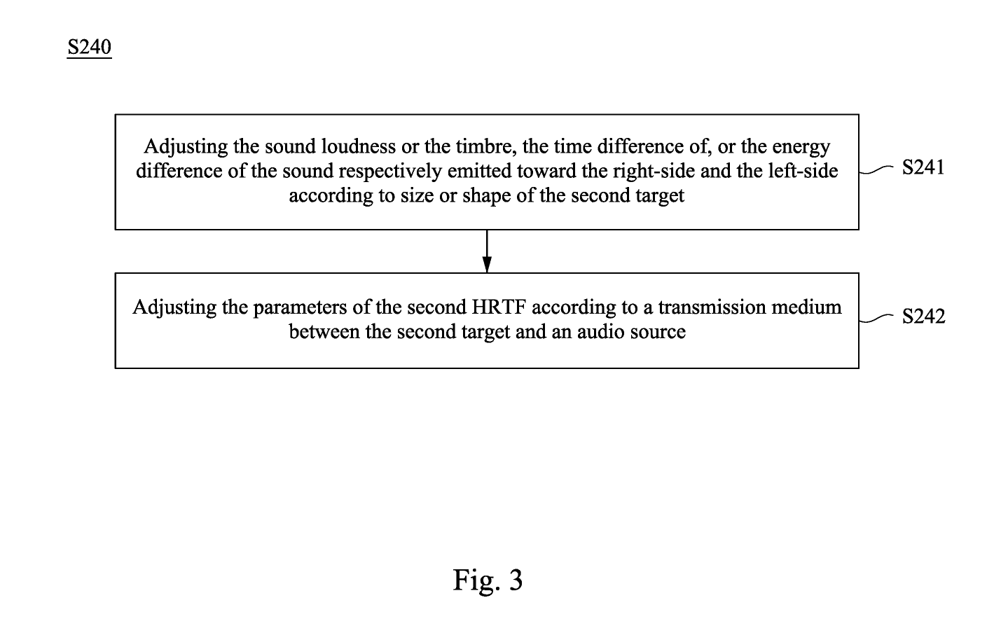

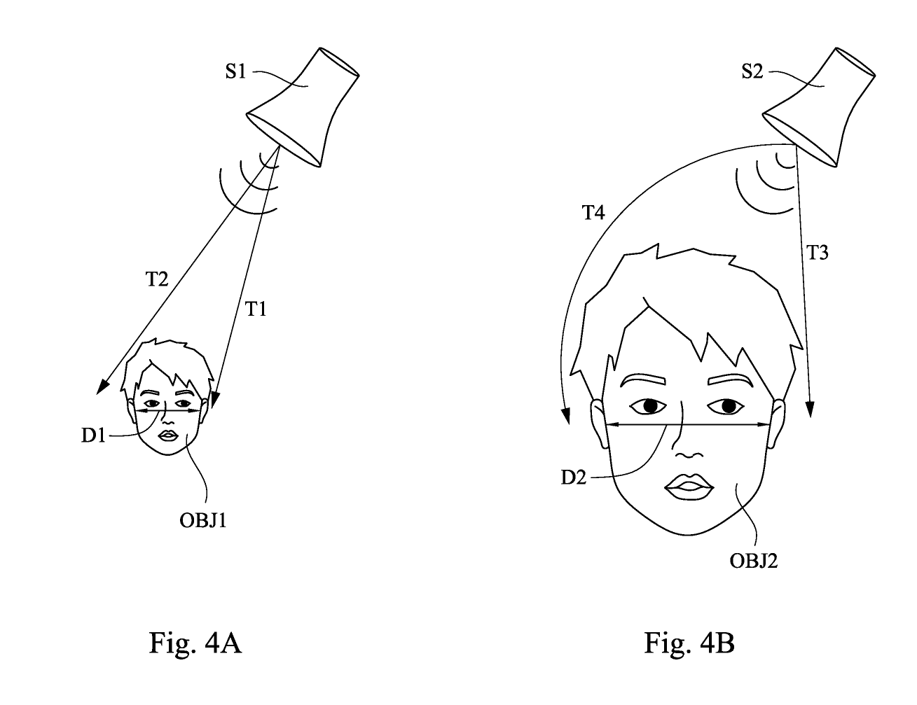

Afterward, the audio signal processing method 200 executes step S240 to modify a second HRTF according to the parameters of the second target. The step S240 further includes steps S241˜S242, reference is made to FIG. 3, which is a flow diagram illustrating step S240 according to an embodiment of this disclosure. Reference is made to FIG. 4A and FIG. 4B, which are schematic diagram illustrating the head shape of avatar. As shown in FIG. 4A, the head of the target OBJ1 is a default head, in common case, the default head is a human head. In the virtual reality environment, the user can be allowed to change his/her avatar into different identities or appearances. For example, the user can transform into another person, a goddess, another animal, a vehicle, a statue, an aircraft, a robot, etc. Each of the identities or appearances may receive the sound from the audio source S1 in different amplitudes or qualities.

Afterwards the audio signal processing method 200 executes step S241 to adjust the sound loudness or the timbre, the time difference of, or the energy difference of the sound respectively emitted toward the right-side and the left-side according to size or shape of the second target. For example, the avatar could have the non-human appearance, as an embodiment shown in FIG. 4B, the user can be transformed into a giant. In FIG. 4B, the head of the target OBJ2 is a head of the giant. A distance D2 between two ears of the target OBJ2 is larger than a distance D1 between two ears of the target OBJ1.

As shown in FIG. 4A and FIG. 4A, it is assumed that a distance between a target OBJ1 and an audio source S1 is same as a distance between a target OBJ2 and an audio source S2, and size of the head and the ears of the target OBJ2 are different from the target OBJ1. Because a distance D2 between two ears of the target OBJ2 is larger than a distance D1 between two ears of the target OBJ1, and therefore the time difference between two ears of the target OBJ2 is larger than the time difference between two ears of the target OBJ1. Thus, when the audio signal is emitted from the audio source S2, the left-side of the audio signal should be delayed (e.g. delay 2 seconds). From the above, the time T1 of right ear hears the sound emitted from the audio source S1 is similar with the time T2 of left ear hears the sound emitted from the audio source S1. The time T3 of right ear hears the sound emitted from the audio source S2 is earlier than the time T4 of left ear hears the sound emitted from the audio source S2, because size of the head of the target OBJ2.

Moreover, the audio signal processing method 200 may adjust the time configuration of the parameters of the second HRTF including a time difference between two ear channels, or delay times to both ear channels. The giant can be configured to receive sound after a delay time. In this case, the target OBJ1 is a default head (e.g. a human head), and therefore the ears of the target OBJ1 are capable of receiving the sound in a normal time. In contrast, the ears of the target OBJ2 is the giant head, when the ears of the target OBJ2 receive the sound, it could be delayed (e.g. delay 2 seconds). The time configuration could be changed (e.g. delay or early) by the appearance of avatar. The design about the time configuration is configured to adapt different avatar, when the user changes different avatar from the target OBJ1 to the target OBJ2, it will be the different the target parameters and adjust the parameters of the HRTF according to the target parameters.

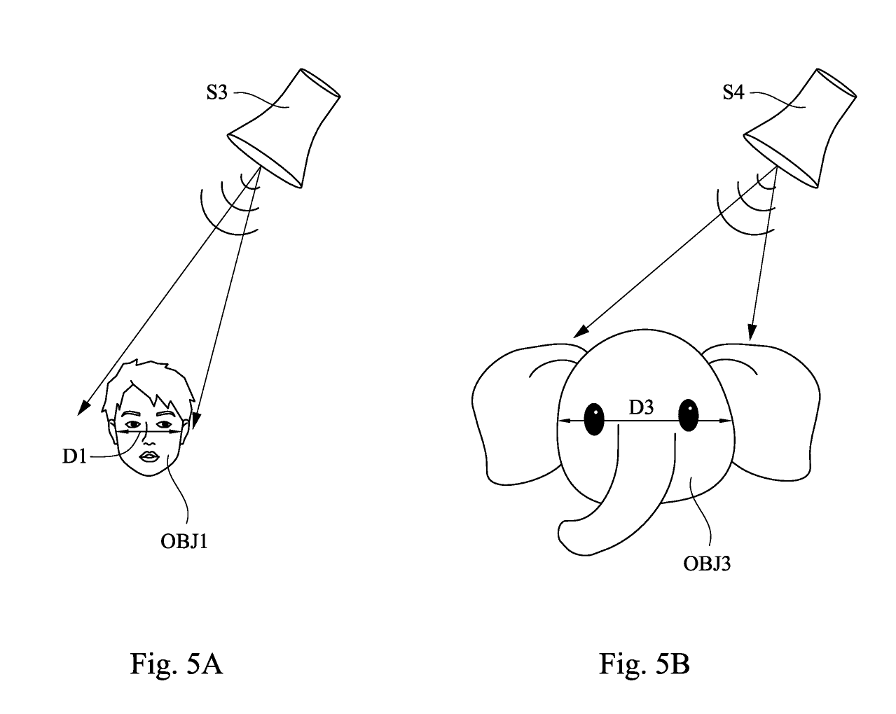

Afterward, reference is made to FIG. 5A and FIG. 5B, which are schematic diagram illustrating the head shape of avatar. As shown in FIG. 5A and FIG. 5B, the head of the target OBJ1 is a default head and the head of the target OBJ3 is a head of elephant. A distance D3 between two ears of the target OBJ3 is larger than a distance D1 between two ears of the target OBJ1. In the embodiment, it is assumed that the sound loudness of the audio source S3 is the same as the sound loudness of the audio source S4. Because size of the ears and head of the target OBJ1 are smaller than size of the ears and head of the target OBJ3, the sound loudness heard by the target OBJ1 will be whisper than the sound loudness heard by the target OBJ3.

Afterward, as shown in FIG. 5A and FIG. 5B, because size of the ears and head of the target OBJ1 are smaller than size of the ears and head of the target OBJ3 and the ear cavity of the target OBJ1 is also smaller than the ear cavity of the target OBJ3, the timbre heard by the target OBJ3 will be lower than the timbre heard by the target OBJ1. Even though, the frequency of the audio source S3 emitted is similar with the frequency of the audio source S4. Moreover, a distance D3 between two ears of the target OBJ3 is larger than the distance D1 between two ears of the target OBJ1, and therefore the time difference or the energy difference between two ears of the target OBJ3 is larger than the time difference or the energy difference between two ears of the target OBJ1. Because the time difference or the energy difference between two ears will be changed by the size of the head, the time difference or the energy difference between the right-side and the left-side is necessary to be adjusted. In this case, when the audio signal is emitted from the audio source S3, the right-side and the left-side are not necessary to be delayed. But, when the audio signal is emitted from the audio source S4, the left-side of the audio signal should be delayed (e.g. delay 2 seconds).

The avatar is not limited to the elephant head. In another embodiment, when the avatar of the user is transformed into a bat. The target is a head of the bat (not shown in figures). The bat is more sensitive to a frequency of an ultrasound. In this case, a sound signal generated by the audio source S1 will pass a frequency converter which converts an ultrasonic sound into an acoustic sound. In this case, the user can be hear the sound frequency noticeable by the bat in the virtual reality environment.

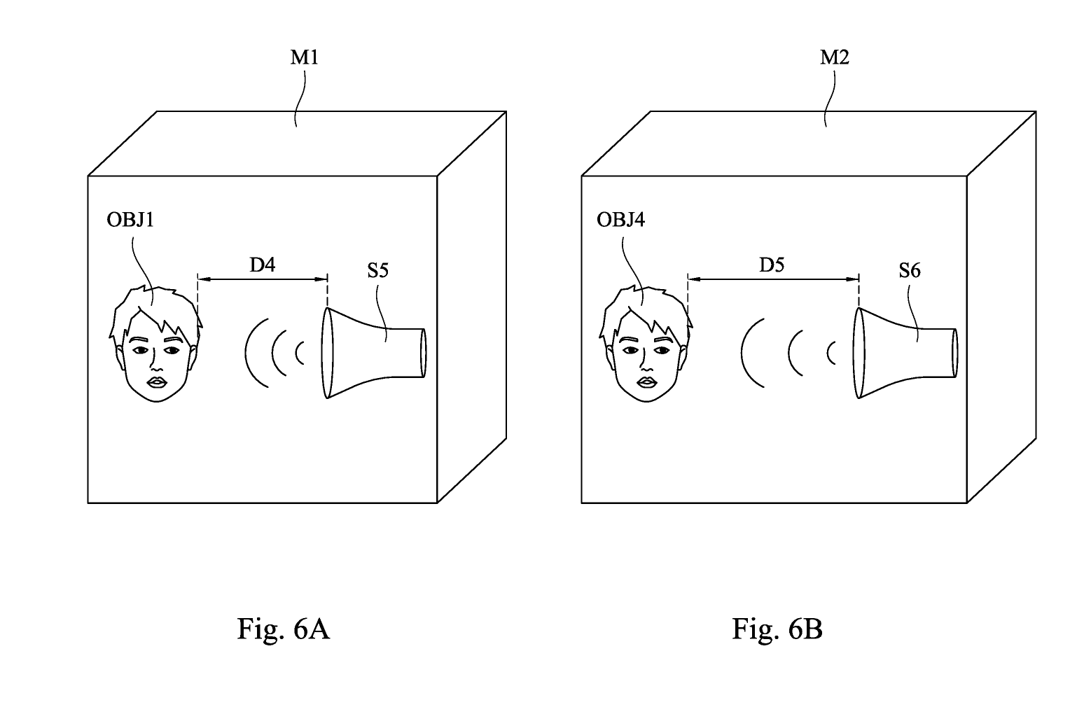

Afterward, the audio signal processing method 200 executes step S242 to adjust the parameter (e.g., the timbre and/or the loudness) of the HRTF according to the transmission medium between the target and the audio source. Reference is made to FIG. 6A and FIG. 6B, which are schematic diagram illustrating relation between the target and the audio source. As shown in FIG. 6A and FIG. 6B, it is assume that a distance D4 between a target OBJ1 and an audio source S5 is same as a distance D5 between a target OBJ4 and an audio source S6. In the embodiment shown in FIG. 6A, the audio source S5 broadcasts the audio signal in a transmission medium M1. The target OBJ1 collects the audio signal from the audio source S5 through the transmission medium M1. In the embodiment shown in FIG. 6B, the audio source S6 broadcasts the audio signal in a transmission medium M2. The target OBJ4 collects the audio signal from the audio source S6 through the transmission medium M2. In this case, the transmission medium M1 can be implemented by environment filled air, and the transmission medium M2 can be implemented by environment filled water. In another embodiment, the transmission medium M1 and M2 also can be implemented by target had specific material (e.g. metal, plastic, and/or any of mixed material) between the audio source S5 and S6 and the target OBJ1 and OBJ4.

Afterward, it is assume that the hearing of the target OBJ4 is similar with the hearing of the target OBJ1, the audio source S6 emits an audio signal and penetrates the transmission medium M1. When the target OBJ4 received the audio signal, the timbre heard by the target OBJ4 is different from the timbre heard by the target OBJ1, even though the sound loudness of the audio source S6 is the same as the sound loudness of the audio source S5. Therefore, the processor 120 is configured to adjust the timbre heard by the target OBJ1 and OBJ4 according to the transmission medium M1 and M2.

Afterward, the audio signal processing method 200 executes step S250 to apply the second HRTF onto the audio positional model corresponding to the first target to generate an audio signal. In the embodiment, the audio positional model is capable to be adjusted by the second HRTF. The modified audio positional model is utilized to adjust an audio signal; afterward, the audio outputting module 110 is configured to output the modified audio signal.

In the embodiment, the head-mounted device is capable of displaying different avatars in the virtual reality system, and it is worth noting that the avatar could be non-human. Therefore, the HRTF is modified by the target parameters of the avatar and the audio positional model of the avatar is determined by the modified HRTF, if the other avatar is loaded, the HRTF will be re-adjusted by the target parameters of the new avatar. In other words, audio signal emitted from the same audio source may cause that user's sense of hearing will be different due to different avatar.

Based on aforesaid embodiments, the audio signal processing method is capable of modifying the parameters of the HRTF according to the parameters of character, modifying the audio signal according to the modified HRTF and outputting the audio signal. The audio signal is able to be modified according to different parameters of avatar.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An audio signal processing method, comprising:
determining, by a processor, whether a first head related transfer function (HRTF) is selected to be applied onto an audio positional model corresponding to a first target or not;
loading, by the processor, a plurality of parameters of a second target if the first HRTF is not selected;
modifying, by the processor, a second HRTF according to the parameters of the second target; and
applying, by the processor, the second HRTF onto the audio positional model corresponding to the first target to generate an audio signal.

2. The audio signal processing method of claim 1, wherein the parameters of the second target comprise a sound loudness, a timbre, an energy difference of an audio source respectively emitted toward a right-side and a left-side of the second target, and/or a time configuration toward the right-side and the left-side.

3. The audio signal processing method of claim 2, wherein the time configuration comprises a time difference of the audio source respectively emitted toward the right-side and the left-side.

4. The audio signal processing method of claim 3, the step of modifying the parameters of the second HRTF according to the parameters of the second target, further comprises:
adjusting the sound loudness or the timbre, the time difference of, or the energy difference of the sound respectively emitted toward the right-side and the left-side according to size or shape of the second target.

5. The audio signal processing method of claim 1, further comprising:
adjusting the parameters of the second HRTF according to a transmission medium between the second target and an audio source.

6. The audio signal processing method of claim 1, wherein the parameter of the second target comprises a character simulating parameter set of an avatar.

7. The audio signal processing method of claim 1, further comprising:
detecting parameters of the first HRTF by a plurality of sensors of a head-mounted device.

8. An audio positional system, comprising:
an audio outputting module;
a processor, connected to the audio outputting module; and
a non-transitory computer-readable medium comprising one or more sequences of instructions to be executed by the processor for performing an audio signal processing method, comprising:
determining, by the processor, whether a first head related transfer function (HRTF) is selected to be applied onto an audio positional model corresponding to a first target or not;
loading, by the processor, a plurality of parameters of a second target if the first HRTF is not selected;
modifying, by the processor, a second HRTF according to the parameters of the second target; and
applying, by the processor, the second HRTF onto the audio positional model corresponding to the first target to generate an audio signal.

9. The audio positional system of claim 8, wherein the parameters of the second target comprise a sound loudness, a timbre, an energy difference of an audio source respectively emitted toward a right-side and a left-side of the second target, and/or a time configuration toward the right-side and the left-side.

10. The audio positional system of claim 9, wherein the time configuration comprises a time difference of the audio source respectively emitted toward the right-side and the left-side.

11. The audio positional system of claim 10, wherein the step of modifying the parameters of the second HRTF according to the parameters of the second target, further comprises:
adjusting the sound loudness or the timbre , the time difference of, or the energy difference of the sound respectively emitted toward the right-side and the left-side according to size or shape of the second target.

12. The audio positional system of claim of claim 8, further comprising:
adjusting the parameters of the second HRTF according to a transmission medium between the second target and an audio source.

13. The audio positional system of claim 8, wherein the parameter of the second target comprises a character simulating parameter set of an avatar.

14. The audio positional system of claim 8, further comprising:
detecting parameters of the first HRTF by a plurality of sensors of a head-mounted device.

15. A non-transitory computer-readable medium including one or more sequences of instructions to be executed by a processor of an electronic device for performing an audio signal processing method, wherein the audio signal processing method comprises:
determining, by a processor, whether a first head related transfer function (HRTF) is selected to be applied onto an audio positional model corresponding to a first target or not;
loading, by the processor, a plurality of parameters of a second target if the first HRTF is not selected;
modifying, by the processor, a second HRTF according to the parameters of the second target; and
applying, by the processor, the second HRTF onto the audio positional model corresponding to the first target to generate an audio signal.

16. The non-transitory computer-readable medium of claim 15, wherein the parameters comprise of the second target a sound loudness, a timbre, an energy difference of an audio source respectively emitted toward a right-side and a left-side of the second target, and/or a time configuration toward the right-side and the left-side; and
wherein the time configuration comprises a time difference of the audio source respectively emitted toward the right-side and the left-side.

17. The non-transitory computer-readable medium of claim 16, the step of modifying the parameters of the second HRTF according to the parameters of the second target, further comprises:
adjusting the sound loudness or the timbre, the time difference of, or the energy difference of the sound respectively emitted toward the right-side and the left-side according to size or shape of the second target.

18. The non-transitory computer-readable medium of claim 15, further comprising:
adjusting the parameters of the second HRTF according to a transmission medium between the second target and an audio source.

19. The non-transitory computer-readable medium of claim 15, wherein the parameter of the second target comprises a character simulating parameter set of an avatar.

20. The non-transitory computer-readable medium of claim 15, further comprising:
detecting parameters of the first HRTF by a plurality of sensors of a head-mounted device.
